(19) United States
(12) Patent Application Publication
(10) Pub. No.: US 2010/0232573 A1
(43) Pub. Date: Sep. 16, 2010

(54) CARDIOVASCULAR X-RAY DIAGNOSTIC SYSTEM

(75) Inventors: Masahiro OZAWA, Sakura-Shi (JP); Takayuki Ishikawa, Nasushiobara-Shi (JP); Yuichiro Watanabe, Yaita-Shi (JP)

Correspondence Address: OBLON, SPIVAK, MCCLELLAND MAIER & NEUSTADT, L.L.P., 1940 DUKE STREET, ALEXANDRIA, VA, 22314, US

(73) Assignees: KABUSHIKI KAISHA TOSHIBA, Tokyo (JP); TOSHIBA MEDICAL SYSTEMS CORPORATION, Otawara-Shi (JP)

(21) Appl. No.: 12/723,023

(22) Filed: Mar. 12, 2010

(30) Foreign Application Priority Data
Mar. 13, 2009 (JP) 2009-061941

(51) Int. Cl. H05G 1/10

(52) U.S. Cl. 378/95

(57) ABSTRACT

A cardiovascular x-ray diagnostic system capable of taking radiographs at different positions by moving at least one of a tabletop on which a subject is placed and a radiographic system equipped with an x-ray tube and an x-ray detector includes: an acquisition unit configured to acquire a radiography position from a position of the tabletop and a position of the radiographic system; a reference position identification unit configured to identify a reference radiography position; and a radiographic unit configured to take radiographs by changing a radiographic parameter based on a current radiography position acquired by the acquisition unit and the reference radiography position.

### BACKGROUND OF THE INVENTION

1. Field of the Invention

The present invention relates to a cardiovascular x-ray diagnostic system which selects and sets optimum radiographic programs and radiographic conditions/parameters whenever necessary depending on areas to be radiographed when taking radiographs while moving a subject.

2. Description of the Related Art

Recently, by taking advantage of their real-time nature, cardiovascular x-ray diagnostic systems have come to support treatments, including IVR (interventional radiology), which use a catheter, in addition to supporting conventional routine examinations for diagnosis. In catheter treatments (such as IVR) and examinations for stenotic diseases of coronary arteries, to allow for possible intercurrent stenotic diseases of arteries in lower extremities, sometimes the arteries in the lower extremities are angiographically checked after a series of coronary angiography sessions and treatments. In angiography, to take radiographs (angiograms) over the widest possible range by a single injection of a contrast medium and thereby reduce the amount of a contrast medium, digital angiography (sliding DA) is performed by greatly translating a tabletop in a longitudinal direction (head-to-foot direction of a patient), for example, with the tabletop slid manually by an operator.

In so doing, a thin flexible catheter and wire guide are used, raising a visibility problem with fluoroscopic and radiographic images. That is, fluoroscopy and radiography using a thin catheter and wire guide produce low-contrast images, making it difficult to see inside body tissues on x-ray images. Therefore, when performing fluoroscopy and radiography using a catheter and wire guide, it is necessary to closely control x-ray conditions and optimize image display parameters.

Conventionally, in an automatic x-ray condition setting mechanism, multiple combinations of standard values concerning location, shape, and brightness of ROI (region of interest) are set in advance for each body area or procedure, and the operator is supposed to select optimum x-ray conditions from among combinations using a switch, but the switching is troublesome for the operator.

To deal with this problem, an automatic condition setting mechanism for an x-ray apparatus has been proposed, where the mechanism is capable of automatically setting optimum x-ray conditions and image display parameters according to areas and procedures without manual switching by an operator (see Japanese Patent Publication of Unexamined Applications (Kokai), No. 2002-238884). The automatic condition setting function for an x-ray apparatus involves prestoring patient information and user information as well as a table which describes optimum x-ray conditions and image display parameters depending on areas and procedures, identifying a procedure based on user information, identifying an ROI for the x-ray apparatus based on a combination of patient information, C-arm position information, and tabletop position information, and extracting the optimum x-ray conditions and image display parameters for a desired area and procedure by referring to the table based on the identified procedure and ROI.

Since methods which set x-ray conditions based on arm and tabletop positions do not take displacement between the tabletop and patient into consideration, radiographic conditions (x-ray conditions) could not be set properly depending on a physical build and a lying position of the patient.

When sliding DA of the lower extremities is performed, since there are differences in object thickness between coronary arteries and arteries in the lower extremities, in order to collect appropriate images, it is necessary to set radiographic conditions separately depending on an object thickness. In particular, when radiographs are taken in a portion extending from a pelvis to toes where the object thickness varies greatly, tube current falls greatly near the toes where the object thickness is small, causing bones to stand out clearly with increased contrast. Consequently, it becomes difficult, in terms of contrast, to distinguish the bones from a contrast medium which has thinned out by flowing down to tips, and thus difficult for the operator to visually recognize images.

Therefore, when performing sliding DA to radiograph the portion extending from the pelvis to the toes in a single session, the operator needs to manually switch to a radiographic program configured such that the tube current will not fall too much near the toes even if the object thickness decreases. However, the operator might forget to switch the radiographic program and radiographic condition parameters before starting sliding DA of the lower extremities, possibly resulting in a failure to collect appropriate radiographic images.

### SUMMARY OF THE INVENTION

The present invention has been made in view of the above circumstances and has an object to provide a cardiovascular x-ray diagnostic system which can collect appropriate images and carry out examinations smoothly even when an area to be radiographed is changed during sliding DA, without a need for a user to manually switch a radiographic program and radiographic parameters according to the area to be radiographed.

To solve the above problem, the present invention provides a cardiovascular x-ray diagnostic system capable of taking radiographs at different positions by moving at least one of a tabletop on which a subject is placed and a radiographic system equipped with an x-ray tube and an x-ray detector, wherein the cardiovascular x-ray diagnostic system acquires information regarding a radiography position and performs radiography by changing radiographic parameters based on the radiography position.

Further, the present invention provides a cardiovascular x-ray diagnostic system capable of taking radiographs at different positions by moving at least one of a tabletop on which a subject is placed and a radiographic system equipped with an x-ray tube and an x-ray detector, the system comprising: an acquisition unit configured to acquire a radiography position from a position of the tabletop and a position of the radiographic system; a reference position identification unit configured to identify a reference radiography position; and a radiographic unit configured to take radiographs by changing a radiographic parameter based on a current radiography position acquired by the acquisition unit and the reference radiography position.

Since the cardiovascular x-ray diagnostic system according to the present invention continues radiography by changing a radiographic program and radiographic condition parameters based on a position of the tabletop even if the area to be radiographed is changed during sliding DA, the cardiovascular x-ray diagnostic system can collect appropriate images and carry out examinations smoothly without a need for a user to manually switch the radiographic program and radiographic condition program according to the area to be radiographed.

### BRIEF DESCRIPTION OF THE DRAWINGS

In the accompanying drawings:

FIG. 1 is a block diagram showing a general configuration of a cardiovascular x-ray diagnostic system according to the present invention;

FIG. 2 is a block diagram showing a configuration of the cardiovascular x-ray diagnostic system according to the present invention;

FIG. 3 is a diagram showing radiographic coverage of sliding DA performed by the cardiovascular x-ray diagnostic system according to the present invention;

FIG. 4 is a flowchart showing procedures of a radiography control process when average tabletop position is used in the cardiovascular x-ray diagnostic system according to the present invention;

FIG. 5 is a diagram for illustrating the radiography control process when the average tabletop position is used in the cardiovascular x-ray diagnostic system according to the present invention;

FIG. 6 is a flowchart showing procedures of a radiography control process when fluoroscopy is performed at a puncture site by the cardiovascular x-ray diagnostic system according to the present invention; and

FIGS. 7A and 7B are diagrams for illustrating the radiography control process when fluoroscopy is performed at a puncture site by the cardiovascular x-ray diagnostic system according to the present invention.

### DETAILED DESCRIPTION

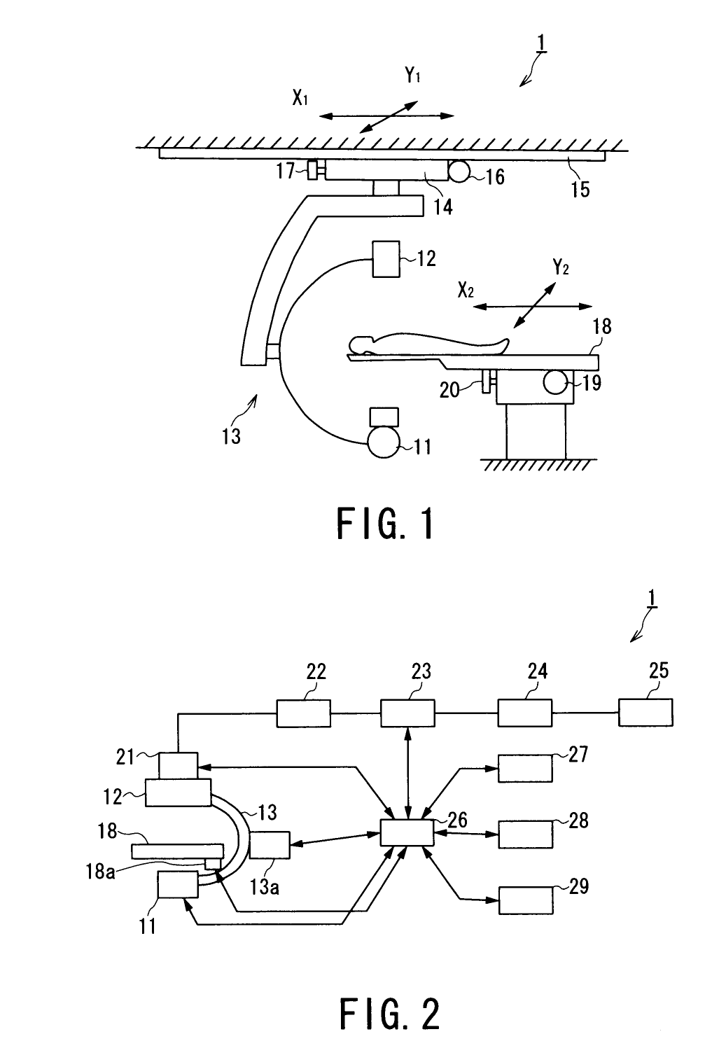

An embodiment of a cardiovascular x-ray diagnostic system according to the present invention will be described in detail with reference to the accompanying drawings. FIG. 1 is a diagram generally showing an overall configuration of the cardiovascular x-ray diagnostic system 1 according to the present invention and FIG. 2 is a block diagram showing the cardiovascular x-ray diagnostic system 1 according to the present invention.

As shown in FIGS. 1 and 2, the cardiovascular x-ray diagnostic system 1 includes an x-ray generator 11, x-ray receiver 12, and arm 13, where the x-ray generator 11 generates and emits x-rays, the x-ray receiver 12 detects x-rays passing through a subject and converts the x-rays into an electrical signal for imaging, and the arm 13 holds the x-ray generator 11 and x-ray receiver 12 in such a way as to face each other.

The x-ray generator 11 includes an X-ray tube, a diaphragm which limits an x-ray irradiation region, and a high-voltage generator which applies a high voltage to the X-ray tube to generate x-rays. On the other hand, the x-ray receiver 12 includes an image intensifier which converts the x-rays passing through the subject into an optical image. Incidentally, a flat panel detector may be used instead of the image intensifier.

The arm 13 moves by being controlled by an arm drive 13a to allow various areas of the subject to undergo fluoroscopy and radiography from various angles. The arm 13 is moved to adjust its position relative to the subject (tabletop 18). Fluoroscopy is a technique for collecting moving images using relatively low dosages of x-rays, while radiography is a technique for collecting high-quality images using relatively high dosages of x-rays. The arm 13 includes a carriage 14 which moves in a body axis direction and a left-right direction of the subject, and a ceiling rail 15 which holds and guides the carriage 14 traveling along a ceiling. The arm 13 has its movement controlled by being guided by the carriage 14 and ceiling rail 15 under the control of the arm drive 13a. A position (X1) of the carriage 14 (i.e., a position of the x-ray generator 11 and x-ray receiver 12) in the body axis direction is detected by a position detector 16 and a position (Y1) of the carriage 14 in the left-right direction is detected by a position detector 17. The position detectors 16 and 17 are, for example, potentiometers.

In addition, the cardiovascular x-ray diagnostic system 1 has a tabletop 18, i.e., a bed on which the subject can lie down, between the x-ray generator 11 and x-ray receiver 12. The tabletop 18 moves by being controlled by a tabletop drive 18a to adjust its position relative to the x-ray generator 11 and x-ray receiver 12. That is, the tabletop 18 has its movement controlled by a travel mechanism movable in the body axis direction and left-right direction of the subject (tabletop 18). A position (X2) of the tabletop 18 (i.e., the position of the subject) in the body axis direction is detected by a position detector 19 and position (Y2) of the tabletop 18 (the position of the subject) in the left-right direction is detected by a position detector 20. The position detectors 19 and 20 are, for example, potentiometers.

Further, the cardiovascular x-ray diagnostic system 1 includes an x-ray TV camera 21 which converts an optical image received by the x-ray receiver 12 into a video signal, an A/D converter 22 which converts an analog video signal acquired from the x-ray TV camera into a digital video signal, an image memory 23 which stores the digital video signal converted by the A/D converter 22, a D/A converter 24 which converts the digital video signal stored in the image memory 23 into an analog video signal, and a monitor 25 which displays the analog video signal converted by the D/A converter 24.

Furthermore, the cardiovascular x-ray diagnostic system 1 includes a CPU (central processing unit) 26 which integrally controls the system, an image storage 27, input/output device 28, and position information storage 29. The CPU 26 performs a radiography control process (described later) and various other processes including computational and control processes.

X-ray irradiation as well as the arm drive 13a and tabletop drive 18a are controlled remotely from a console (not shown). The console is provided with an x-ray irradiation switch, arm control unit, and tabletop control unit as well as an input device for use to enter patient information and user information. For start stop control of digital angiography, the console is also provided with a foot pedal which causes radiography to be started when pressed with foot of a user (such as a medical doctor or medical physician), to be continued while being pressed, and to be stopped when released.

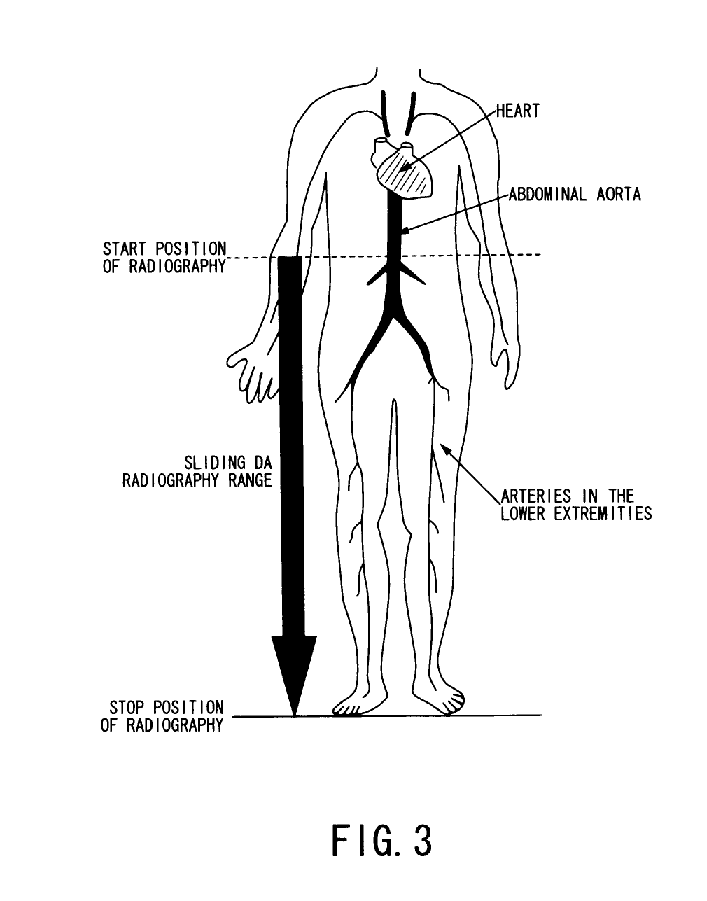

Recently, by taking advantage of their real-time nature, cardiovascular x-ray diagnostic systems have come to support treatments, including IVR (interventional radiology), which use a catheter, in addition to supporting conventional routine examinations for diagnosis. In catheter treatments (such as IVR) and examinations for stenotic diseases of coronary arteries, to allow for possible intercurrent stenotic diseases of arteries in lower extremities, sometimes the arteries in the lower extremities are angiographically checked after a series of coronary angiography sessions and treatments. In angiography, to take radiographs (angiograms) over the widest possible range by a single injection of a contrast medium and thereby reduce the amount of a contrast medium, digital angiography (sliding DA) is performed by widely moving the tabletop 18 in a longitudinal direction (head-to-foot direction of the patient, i.e., X2 direction on FIG. 1), for example, with the tabletop 18 slid manually by the user. In sliding DA, the subject is radiographed from an abdominal aorta to the arteries in the lower extremities while the tabletop 18 is being slid such that the x-ray generator 11 and x-ray receiver 12 will move from an abdomen to toes relative to the subject, for example, as shown in FIG. 3.

In so doing, a thin flexible catheter and wire guide raise a visibility problem in fluoroscopy and radiography. The thin catheter and wire guide used in fluoroscopy and radiography provide low contrast, and are difficult to see inside the body tissues on x-ray images. Therefore, it is necessary to set x-ray conditions precisely and optimize image display parameters.

When sliding DA of the lower extremities is performed, since there are differences in object thickness between the coronary arteries and the arteries in the lower extremities, appropriate images cannot be collected unless radiographic conditions are changed. In particular, when radiographs are taken in a portion extending from a pelvis to the toes where the object thickness varies greatly, tube current falls greatly near the toes where the object thickness is small, causing bones to stand out clearly with increased contrast. Consequently, it becomes difficult, in terms of contrast, to distinguish bones from the contrast medium which has thinned out by flowing down to the tips, and thus difficult for the user (such as a surgeon) to visually recognize images.

Therefore, when performing sliding DA to radiograph the portion extending from the pelvis to the toes in a single session, the user needs to manually switch to a radiographic program configured such that the tube current will not fall too much near the toes even if the object thickness decreases. In the radiographic program selected in this case, radiographic parameters are set exclusively for the lower extremities, where the radiographic parameters include, for example, an operating tube voltage range and a ROI size and location for automatic brightness control. Besides, since the lower extremities do not produce pulsations, a collection rate for the lower extremities is set lower than for the coronary arteries. However, the program switching is troublesome for the user. Also, the user might forget to switch to an appropriate radiographic program before starting sliding DA of the lower extremities, possibly resulting in a failure to collect appropriate radiographic images.

To deal with this, the cardiovascular x-ray diagnostic system 1 has a capability to collect images properly without the need for the user to manually switch the radiographic program according to the object to be radiographed even in the case of sliding DA. Specifically, the cardiovascular x-ray diagnostic system 1 stores the position of the tabletop 18 during radiography of the coronary arteries. Then, if the position of the tabletop 18 is moved more than a predetermined distance (adjustable on a patient-by-patient basis) from the stored tabletop position during radiography of the lower extremities, the cardiovascular x-ray diagnostic system 1 continues radiography by changing the radiographic program or radiographic parameters to the radiographic program or radiographic parameters for the lower extremities.

The cardiovascular x-ray diagnostic system 1 performs sliding DA as follows. At a command from the user via the input/output device 28, the arm 13 and the tabletop 18 are moved and positioned at a desired observation site, and then radiographic conditions and collection conditions are determined. Then, as the user gives a command via the input/output device 28 to start collection, x-ray images start to be collected. Regarding the number of images to be collected, either a single frame (one-shot radiography) or multiple frames (cinema radiography or motion radiography) may be collected. Even during fluoroscopy, fluoroscopic images can be collected.

Collected images, together with information concerning the collection (additional image information), are stored in the image memory 23 and displayed on the monitor 25. Also, at a command from the user via the input/output device 28, any x-ray image is read from the image storage 27 to the image memory 23 and displayed on the monitor 25 in order to be viewed during diagnosis. In the case of sliding DA, the operator manually slides and moves the tabletop 18 during the radiography process while watching blood flow in blood vessels on the monitor 25.

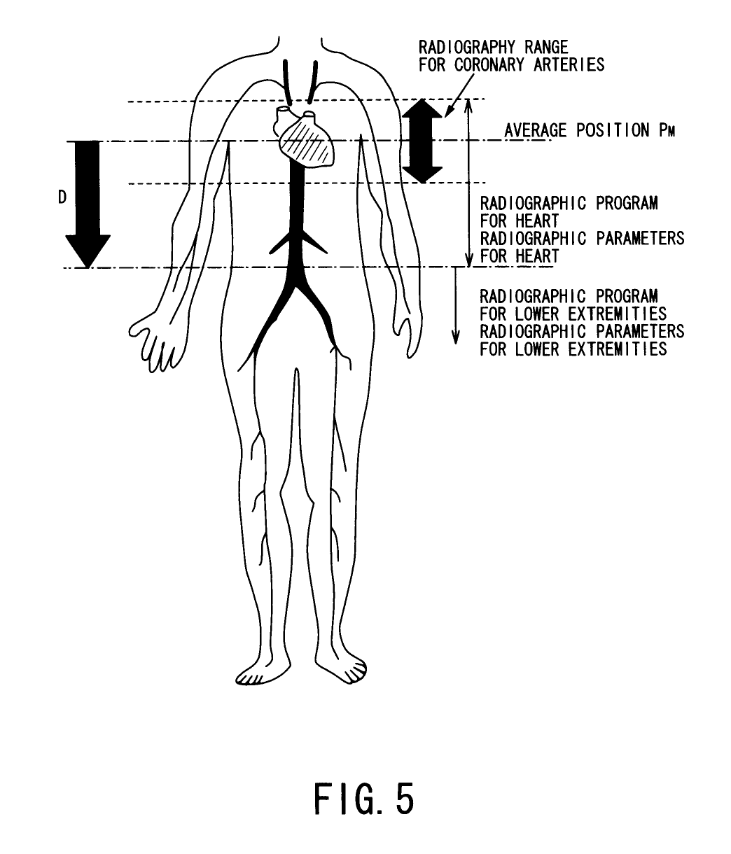

In normal examinations, three segments of the coronary arteries, i.e., left anterior descending artery and circumflex artery of the left coronary artery, and a right coronary artery, are radiographed from angles at which the arteries are easy to observe. Thus, usually, a dozen or so radiographic images are taken. Generally, a heart of the patient is first radiographed (radiography of the coronary arteries), and then radiographs are taken going gradually down to the lower extremities of the patient by manually moving the tabletop 18. In the case that the sliding DA of the lower extremities is performed after radiography of the coronary arteries, the cardiovascular x-ray diagnostic system 1 stores position information about the tabletop 18 successively in the position information storage 29 during radiography of the coronary arteries, calculates an average form the position information, and uses the calculated average tabletop position PM as heart position, as shown in FIG. 5.

Specifically, the cardiovascular x-ray diagnostic system 1 stores position information about the tabletop 18 in the longitudinal direction (head-to-foot direction of the patient) in the position information storage 29 during radiography of the coronary arteries. Also, based on the stored position information, the CPU 26 of the cardiovascular x-ray diagnostic system 1 successively calculates an average value of the tabletop 18 in the longitudinal direction as average tabletop position PM and stores the calculated average tabletop position PM in the position information storage 29.

When the tabletop 18 is manually moved in the longitudinal direction, the CPU 26 of the cardiovascular x-ray diagnostic system 1 checks whether a distance from the position of the tabletop 18 to the latest average tabletop position PM exceeds a distance limit D calculated in advance. If the distance from the position of the tabletop 18 to the latest average tabletop position PM exceeds the distance limit D, the cardiovascular x-ray diagnostic system 1 determines that the lower extremities are radiographed, and performs digital angiography by changing the radiographic program and radiographic parameters to those for the lower extremities.

Regarding the distance limit D, the distance from a heart to an abdomen of an average adult male is stored as default in the position information storage 29. However, if height data is available as patient information at the beginning of examination, a predetermined proportion (e.g., 30%) of the height data is calculated and used as the distance limit D.

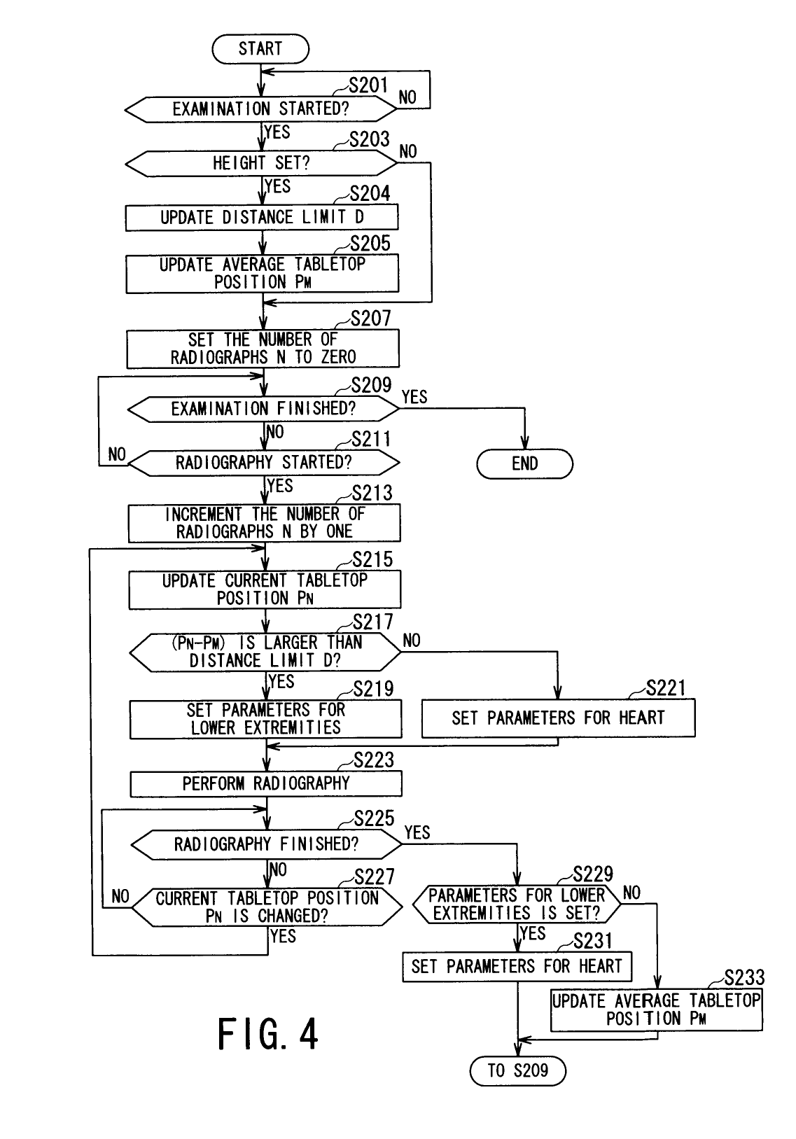

Now, procedures of a radiography control process will be described in detail with reference to a flowchart in FIG. 4, where the procedures are carried out by the cardiovascular x-ray diagnostic system 1 to perform sliding DA in the manner described above by switching the radiographic program and radiographic parameters based on position information about the tabletop 18 in the longitudinal direction, average position information about the tabletop 18 during radiography of the coronary arteries, and distance limit D. In the following description, steps may be referred to, for example, as “S201” (in the case of Step S201”) by omitting the term “Step.”

First, the CPU 26 determines whether or not the cardiovascular x-ray diagnostic system 1 has started an examination (S201). In so doing, the CPU 26 determines that an examination has been started, for example, when power is turned on or when a predetermined operation is performed. If no examination has been started (No in S201), the CPU 26 continues waiting.

If an examination has been started (Yes in S201), the CPU 26 determines whether height has been set (S203). The CPU 26 determines that height has been set if the height has been entered via the input/output device 28. If height has been set (Yes in S203), the CPU 26 updates the distance limit D (S204). In so doing, the CPU 26 uses, for example, a length equal to a predetermined proportion (e.g., 30%) of the height as the distance limit D.

Then, the CPU 26 updates the average tabletop position PM according to the height of the subject (S205). The CPU 26 may set the average tabletop position PM to average position of the tabletop 18 used when the coronary arteries were radiographed in the past, update the average tabletop position PM according to the height of the subject, or omit this process and update the average tabletop position PM when radiography is performed the next time using parameters for the heart (i.e., in Step S233).

Since no radiograph has been taken yet, the CPU 26 sets the number of radiographs N to “0” (S207). Next, the CPU 26 determines whether or not the examination is finished (S209). In so doing, the CPU 26 determines that the examination is finished, for example, when power is turned off or when a predetermined action is performed. When the examination is finished (Yes in S209), the CPU 26 finishes the radiography control process.

If the examination has not been finished (No in S209), the CPU 26 determines whether or not radiography has been started (S211). The user (such as a surgeon) gives a command to start radiography, for example, by pressing a radiography pedal (radiography starting/stopping unit) at his/her feet. Radiography is continued while the radiography pedal is pressed continuously and radiography is stopped when the radiography pedal is released. Thus, the CPU 26 determines that radiography has been started, for example, when the radiography pedal is pressed. If radiography has not been started (No in S211), the CPU 26 returns to Step S209 to determine again whether or not the examination is finished.

If radiography has been started (Yes in S211), the CPU 26 increments the number of radiographs N by 1 (S213). Then, the CPU 26 updates current tabletop position PN which is the current position of the tabletop 18 (S215). Specifically, the CPU 26 acquires the position of the tabletop 18 in the X2 direction from the position detector 19 and establishes the acquired position as the current tabletop position PN.

The CPU 26 calculates a distance (PN-PM) from the average tabletop position PM to the current tabletop position PN updated in Step S215 and determines whether or not the calculated distance is larger than the distance limit D (S217). That is, since the user (such as a surgeon) first radiographs the heart of the patient (radiography of the coronary arteries), and subsequently radiographs the lower extremities by going gradually down to the feet of the patient as shown in FIG. 5, the CPU 26 determines which is being radiographed, the heart or lower extremities, depending on whether or not the distance from the radiography site to the average position of the tabletop 18 (average tabletop position PM) during the radiography of the coronary arteries is larger than the distance limit D.

If the distance (PN-PM) from the average tabletop position PM to the current tabletop position PN updated in Step S215 is larger than the distance limit D (Yes in S217), the CPU 26 determines that the lower extremities are being radiographed and selects the radiographic program and radiographic parameters for the lower extremities (S219).

If the distance (PN-PM) from the average tabletop position PM to the current tabletop position PN updated in Step S215 is smaller than the distance limit D (No in S217), the CPU 26 determines that the heart is being radiographed and selects the radiographic program and radiographic parameters for the heart (S221).

Then, the CPU 26 performs radiography (S223) using the radiographic parameters selected in Step S219 or S221. The CPU 26 determines whether or not the radiography performed in Step S223 is finished (S225). The user (such as a surgeon) gives a command to stop radiography, for example, by releasing a radiography pedal at his/her feet. Thus, the CPU 26 determines that radiography is finished, for example, when the radiography pedal is released.

If radiography is not finished (No in S225), the CPU 26 determines whether or not the current tabletop position PN (which is the current position of the tabletop 18) has been changed since the previous update in Step S215 (S227). Specifically, the CPU 26 acquires the position of the tabletop 18 in the X2 direction from the position detector 19 and checks for any change by comparing the acquired data with the stored data of the current tabletop position PN.

If the current tabletop position PN has not been changed (No in S227), the CPU 26 returns to Step 5225 to determine again whether or not the radiography is finished. If the current tabletop position PN has been changed (Yes in S227), the CPU 26 returns to Step S215 to update the current tabletop position PN again. Then, the CPU 26 performs processes in Steps S217 to S227.

If the radiography is finished (Yes in S225), the CPU 26 determines whether or not the radiographic parameters are set for the lower extremities (S229). If the radiographic parameters for the lower extremities were selected the previous time in Step S219, currently the radiographic parameters are set for the lower extremities.

If the radiographic parameters are set for the lower extremities (Yes in S229), the CPU 26 sets the radiographic program and radiographic parameters to those for the heart (S231). If the radiographic parameters are not set for the lower extremities, i.e., if the radiographic parameters are set for the heart (No in S229), the CPU 26 updates the average tabletop position PM, assuming that the heart has been radiographed (S233). In so doing, the CPU 26 updates the average tabletop position PM, for example, based on Eq. 1 below.

$$\begin{matrix}[ Expression 1 ] & \\ {P}_{M} = \{ {{\sum }_{i = 0}}^{N} Pi \} / N & ( 1 )\end{matrix}$$

The CPU 26 returns to Step S209 again and determines whether or not the examination is finished. The CPU 26 repeats processes in Steps S209 to S233 until the examination is finished and thereby performs the radiography control process.

In this way, the cardiovascular x-ray diagnostic system 1 calculates the average position of the tabletop 18 during radiography of the coronary arteries. Subsequently, when the tabletop 18 is moved manually in the longitudinal direction, the cardiovascular x-ray diagnostic system 1 calculates the distance from the current tabletop position PN to the average tabletop position PM calculated during radiography of the coronary arteries and checks successively whether the distance exceeds the distance limit D. If the distance from the current position PN of the tabletop 18 to the average position of the tabletop 18 exceeds the distance limit D, the cardiovascular x-ray diagnostic system 1 determines that the lower extremities are radiographed, and continues sliding DA by switching the radiographic program and radiographic parameters to those for the lower extremities.

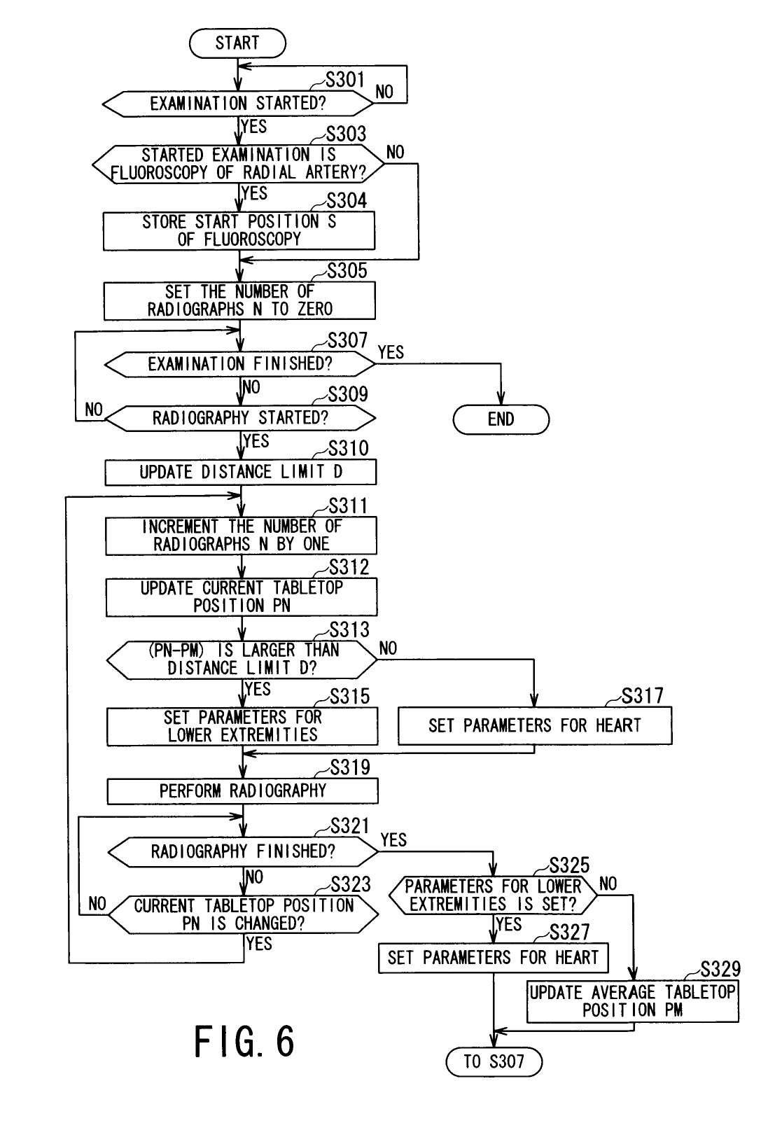

Now, procedures of a radiography control process in the case where fluoroscopy of a radial artery is performed before radiography of the coronary arteries will be described in detail with reference to a flowchart in FIG. 6, where the procedures are carried out by the cardiovascular x-ray diagnostic system 1 to perform sliding DA by switching the radiographic program and radiographic parameters based on position information about the tabletop 18 in the longitudinal direction and position information about the tabletop 18 during insertion of a catheter (i.e., during puncture with the catheter).

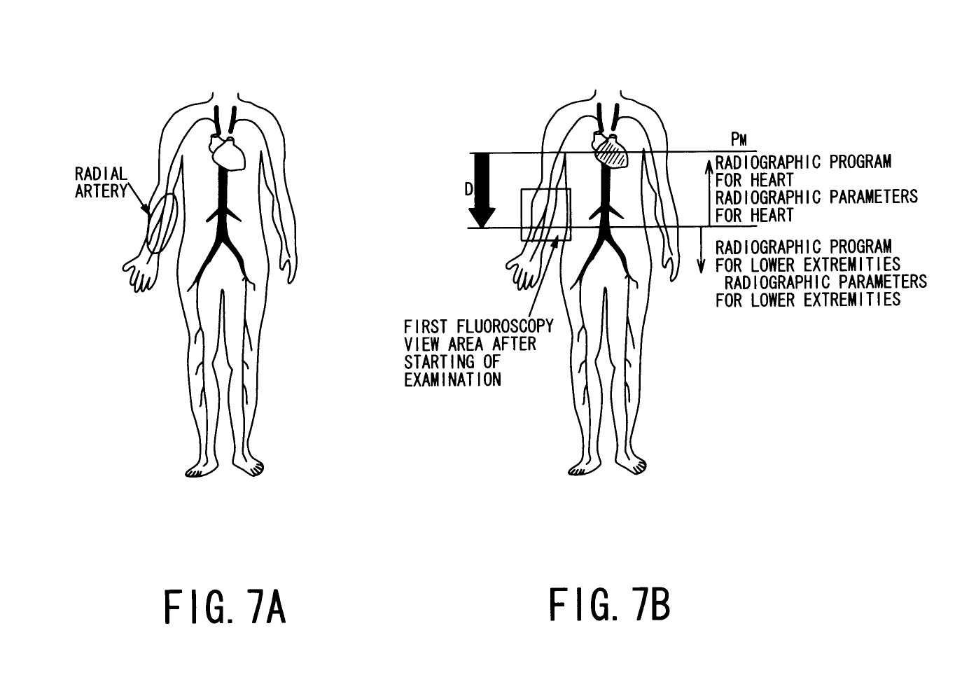

There are cases where fluoroscopy of a radial artery is performed with a catheter inserted into the radial artery located between hand and elbow (i.e., with the radial artery punctured) as shown in FIG. 7A before the cardiovascular x-ray diagnostic system 1 performs radiography of the coronary arteries. In that case, the first fluoroscopy is performed at the puncture site or at a site slightly nearer the upper arm after the puncture. Since the radial arteries are generally located at approximately the same distance from the heart in the longitudinal direction as a junction of the abdominal aorta and the arteries in the lower extremities as shown in FIG. 7B, the cardiovascular x-ray diagnostic system 1 stores the position of the tabletop 18 at the time of the first fluoroscopy in the position information storage 29 as a start position S of fluoroscopy, and establishes the distance limit D by multiplying a weighting factor α by a difference between the start position S of fluoroscopy and an average tabletop position P of the tabletop 18 during radiography of the coronary arteries. Alternatively, the cardiovascular x-ray diagnostic system 1 may establish a larger one of the distance limit determined here and a distance limit determined relatively from the height of the patient, or determine a new distance limit D by assigning predetermined weights to the two distance limits described above.

First, the CPU 26 determines whether or not the cardiovascular x-ray diagnostic system 1 has started an examination (S301). In so doing, the CPU 26 determines that an examination has been started, for example, when power is turned on or when a predetermined operation is performed. If no examination has been started (No in S301), the CPU 26 continues waiting.

If an examination has been started (Yes in S301), the CPU 26 determines whether or not the started examination involves fluoroscopy of a radial artery (S303). The CPU 26 determines whether or not the started examination involves fluoroscopy of a radial artery, for example, based on whether or not a fluoroscopic program has been started. Alternatively, the CPU 26 may determine that the started examination involves fluoroscopy of a radial artery at press of a fluoroscopy pedal (fluoroscopy starting/stopping unit different from the radiography pedal) which, being located at the feet of the user (such as a surgeon), is used by the user to give a command to start fluoroscopy. As in the case of radiography, fluoroscopy is continued while the fluoroscopy pedal is pressed continuously and fluoroscopy is stopped when the fluoroscopy pedal is released.

If the examination involves fluoroscopy of a radial artery (Yes in S303), the CPU 26 stores the position of the tabletop 18 at the time of the first fluoroscopy in the position information storage 29 as the start position S of fluoroscopy (S304). This is because the radial arteries are generally located at approximately the same distance from the heart in the longitudinal direction as the junction of the abdominal aorta and the arteries in the lower extremities and thus the start position S of fluoroscopy can be used for switching between the radiographic programs for the heart and lower extremities. Since no radiograph has been taken yet, the CPU 26 sets the number of radiographs N to “0” (S305).

The CPU 26 determines whether or not the examination is finished (S307). The CPU 26 determines that the examination is finished, for example, when power is turned off or when a predetermined operation is performed. When the examination is finished (Yes in S307), the CPU 26 finishes the radiography control process.

If the examination has not been finished (No in S307), the CPU 26 determines whether or not radiography has been started (S309). The user (such as a surgeon) gives a command to start radiography, for example, by pressing a radiography pedal at his/her feet. Radiography is continued while the radiography pedal is pressed continuously and radiography is stopped when the radiography pedal is released. Thus, the CPU 26 determines that radiography has been started, for example, when the radiography pedal is pressed. If radiography has not been started (No in S309), the CPU 26 returns to Step S307 to determine again whether or not the examination is finished.

If radiography has been started (Yes in S309) and if the examination involves fluoroscopy of a radial artery (Yes in S303), the CPU 26 updates the distance limit D based on the average tabletop position PM and start position S of fluoroscopy (S310). In so doing, the CPU 26 sets, for example, the distance from the average tabletop position PM to the start position S of fluoroscopy as the distance limit D. If the radiography has not been practiced yet, the average tabletop position PM may be set the current tabletop position PN.

The CPU 26 increments the number of radiographs N by 1 (S311). The CPU 26 updates the current tabletop position PN (which is the current position of the tabletop 18) (S312). In so doing, the CPU 26 acquires the position of the tabletop 18 in the X2 direction from the position detector 19 and establishes the position as the current tabletop position PN.

The CPU 26 determines whether or not the distance (PN-PM) from the current tabletop position PN updated in Step S311 to the average tabletop position PM is larger than the distance limit D (S313). That is, since the user (such as a surgeon) first performs fluoroscopy of the radial artery between a wrist and an elbow as shown in FIG. 7B, followed by radiography of the heart (radiography of the coronary arteries), and then performs radiography of the lower extremities by going gradually down to the feet of the patient, the CPU 26 determines whether the heart is being radiographed or the lower extremities are being radiographed based on whether or not the radiographed site has moved closer to the lower extremities than the position of the tabletop 18 (near the start position S of fluoroscopy) located during the fluoroscopy of the radial artery.

If the distance (PN-PM) from the current tabletop position PN updated in Step S312 to the average tabletop position PM is larger than the distance limit D (Yes in S313), the CPU 26 determines that the lower extremities are being radiographed, and sets the radiographic program and radiographic parameters for the lower extremities (S315).

If the distance (PN-PM) from the current tabletop position PN updated in Step S312 to the average tabletop position PM is not larger than the distance limit D (No in S313), the CPU 26 determines that the heart is being radiographed, and sets the radiographic program and radiographic parameters for the heart (S317).

Then, the CPU 26 performs radiography using the radiographic parameters set in Step S315 or 5317 (S319). The CPU 26 determines whether or not the radiography performed in S319 is finished (S321). The user (such as a surgeon) gives a command to stop radiography, for example, by releasing a pedal at his/her feet. Thus, the CPU 26 determines that radiography is finished, for example, when the radiography pedal is released.

If the radiography is not finished (No in S321), the CPU 26 determines whether or not the current tabletop position PN (which is the current position of the tabletop 18) has been changed since the previous update in Step S312 (S323). Specifically, the CPU 26 acquires the position of the tabletop 18 in the X2 direction from the position detector 19 and checks for any change by comparing the acquired data with the stored data of the current tabletop position PN.

If the current tabletop position PN has not been changed (No in S323), the CPU 26 returns to Step S321 to determine again whether or not the radiography is finished. If the current tabletop position PN has been changed (Yes in S323), the CPU 26 returns to Step S311 to increment the number of radiographs N by 1. Then, the CPU 26 performs processes in Steps S312 to S323.

If the radiography is finished (Yes in S321), the CPU 26 determines whether or not the radiographic parameters are set for the lower extremities (S325). If the radiographic parameters for the lower extremities were selected the previous time in Step S315, currently the radiographic parameters are set for the lower extremities.

If the radiographic parameters are set for the lower extremities (Yes in S325), the CPU 26 sets the radiographic program and radiographic parameters to those for the heart (S327). If the radiographic parameters are not set for the lower extremities, i.e., if the radiographic parameters are set for the heart (No in S325), the CPU 26 updates the average tabletop position PM, assuming that the heart has been radiographed (S329). In so doing, the CPU 26 updates the average tabletop position PM, for example, based on Eq. 1.

The CPU 26 returns to Step S307 and determines again whether or not the examination is finished. The CPU 26 repeats processes in Steps S307 to S323 until the examination is finished and thereby performs the radiography control process.

In this way, if radiography of the coronary arteries is performed after fluoroscopy of a radial artery, when the tabletop 18 is moved manually in the longitudinal direction, the cardiovascular x-ray diagnostic system 1 checks successively whether or not the distance from the current position PN of the tabletop 18 to the position PM of the tabletop 18 (average tabletop position PM) during the radiography of the coronary arteries exceeds a distance limit D using the distance from the position of the tabletop 18 at the start of the radiography of the coronary arteries to the start position S of the fluoroscopy of the radial artery as the distance limit D. If the distance from the current position PN of the tabletop 18 to the average tabletop position PM exceeds the distance limit D, the cardiovascular x-ray diagnostic system 1 determines that the lower extremities are radiographed, and continues sliding DA by switching the radiographic program and radiographic parameters to those for the lower extremities.

Incidentally, instead of position information about the tabletop 18, longitudinal position of the arm 13 on the ceiling may be stored in the position information storage 29. In that case, the arm 13 rather than the tabletop 18 is moved manually during sliding DA. Alternatively, both longitudinal position of the arm 13 on the ceiling and longitudinal position of the tabletop 18 may be stored and compared with the distance limit D.

Although radiography of the coronary arteries and fluoroscopy of a radial artery are performed in the embodiment described above, this is not restrictive and radiography/fluoroscopy of any object may be performed. Also, although two areas, namely the coronary arteries (chest) and a radial artery (limb), are subjected to radiography/fluoroscopy in the embodiment, this is not restrictive and the present invention is also applicable to radiography/fluoroscopy of three or more areas including head and waist. In that case, the radiographic program and radiographic parameters can be set based on the position of the arm 13, position of the tabletop 18, or relative position of the arm 13 and tabletop 18.

Since the cardiovascular x-ray diagnostic system 1 according to the present invention continues radiography by changing a radiographic program and radiographic condition parameters based on the position information of the tabletop 18 even if the area to be radiographed is changed during sliding DA, the cardiovascular x-ray diagnostic system 1 can collect appropriate images and carry out examinations smoothly without the need for the user to manually switch the radiographic program and radiographic condition programs according to the area to be radiographed.

What is claimed is:

1. A cardiovascular x-ray diagnostic system capable of taking radiographs at different positions by moving at least one of a tabletop on which a subject is placed and a radiographic system equipped with an x-ray tube and an x-ray detector,
wherein the cardiovascular x-ray diagnostic system acquires information regarding a radiography position and performs radiography by changing radiographic parameters based on the radiography position.

2. A cardiovascular x-ray diagnostic system capable of taking radiographs at different positions by moving at least one of a tabletop on which a subject is placed and a radiographic system equipped with an x-ray tube and an x-ray detector, the system comprising:
an acquisition unit configured to acquire a radiography position from a position of the tabletop and a position of the radiographic system;
a reference position identification unit configured to identify a reference radiography position; and
a radiographic unit configured to take radiographs by changing a radiographic parameter based on a current radiography position acquired by the acquisition unit and the reference radiography position.

3. The cardiovascular x-ray diagnostic system of claim 2, wherein,
the reference position identification unit stores a radiography position at which a predetermined region has been radiographed previously and identifies the reference radiography position based on the stored radiography position.

4. The cardiovascular x-ray diagnostic system of claim 2, wherein,
the radiographic unit sets a first radiographic parameter to take the radiographs when a distance between the reference radiography position and the current radiography position is equal to or shorter than a distance limit, and sets a second radiographic parameter to take the radiographs when the distance is longer than the distance limit.

5. The cardiovascular x-ray diagnostic system of claim 2, wherein,
the reference radiography position corresponds to a position of a heart of the subject, and
the radiographic unit changes the radiographic parameter from the radiographic parameter for the heart to the radiographic parameter for lower extremities, based on the current radiography position acquired by the acquisition unit and the reference radiography position.

6. The cardiovascular x-ray diagnostic system of claim 2, wherein,
the reference position identification unit identifies the reference radiography position by averaging a plurality of radiography positions which have been acquired previously by the acquisition unit.

7. The cardiovascular x-ray diagnostic system of claim 2, wherein,
the reference position identification unit identifies the reference radiography position based on a position at which a radiograph has been taken for the first time for the subject.

8. The cardiovascular x-ray diagnostic system of claim 4, wherein,
the reference position identification unit identifies the reference radiography position based on a position at which a radiograph has been taken for the first time for the subject.

9. The cardiovascular x-ray diagnostic system of claim 5, wherein,
the reference position identification unit identifies the reference radiography position based on a position at which a radiograph has been taken for the first time for the subject.

10. The cardiovascular x-ray diagnostic system of claim 4, wherein,
the radiographic unit determines the distance limit based on a standing height of the subject.

11. A cardiovascular x-ray diagnostic system capable of performing a radiography and a fluoroscopy at different positions by moving at least one of a tabletop on which a subject is placed and a radiographic system equipped with an x-ray tube and an x-ray detector, the system comprising:
a fluoroscopy instruction unit configured to instruct to start the fluoroscopy;
a radiography instruction unit configured to instruct to start the radiography;
an acquisition unit configured to acquire a fluoroscopy position at the time when instructed to start the fluoroscopy by the a fluoroscopy instruction unit and radiography position at the time when instructed to start the radiography by the radiography instruction unit;
a reference position identification unit configured to identify a reference radiography position; and
a radiographic unit configured to take radiographs by changing a radiographic parameter based on the fluoroscopy position, a current radiography position acquired by the acquisition unit, and the reference radiography position.

12. The cardiovascular x-ray diagnostic system of claim 11, wherein,
the radiographic unit sets a first radiographic parameter to take the radiographs when a distance between the reference radiography position and the current radiography position is equal to or shorter than a distance limit, and sets a second radiographic parameter to take the radiographs when the distance is longer than the distance limit, and
the radiographic unit determines the distance limit based on the fluoroscopy position and the reference radiography position.
